(19) United States
(12) Patent Application Publication
(10) Pub. No.: US 2008/0230459 A1
(43) Pub. Date: Sep. 25, 2008

(54) Enhancing Water Mobility Using Low Frequency Pulses

(75) Inventors: Paul Donahue, Corona Del Mar, CA (US); Liam Shanahan, Irvine, CA (US)

Correspondence Address: FISH & RICHARDSON, PC, P.O. BOX 1022, MINNEAPOLIS, MN, 55440-1022, US

(73) Assignee: Aqua-PhyD Inc., Corona Del Mar, CA (US)

(21) Appl. No.: 12/051,777

(22) Filed: Mar. 19, 2008

Related U.S. Application Data
(60) Provisional application No. 60/895,723, filed on Mar. 19, 2007.

(51) Int. Cl. C02F 1/48

(52) U.S. Cl. 210/222; 210/695

(57) ABSTRACT

A method to enhance water flow through a medium includes positioning like poles of two magnets adjacent to create a magnetic flux field at a region corresponding to a position at which the like poles are adjacent, maintaining pressure sufficient to at least partially overcome a quiescent-repulsive force between the adjacent like poles to amplify the magnetic flux field at the region, flowing water through the amplified magnetic flux field at the region at a flow rate selected based on a natural frequency related to a medium through which the water is to flow, the flowing inducing a pulse in the water having a frequency depending on the selected flow rate, and transmitting the water carrying the pulse at the frequency to the medium to produce resonance with the natural frequency of the medium, the resonance causing a decrease in a compaction of the medium.

### CROSS-REFERENCE TO RELATED APPLICATIONS

This application claims priority to U.S. Provisional Application No. 60/895,723, entitled Wave Theory Applications to Soil Particles, to inventor Paul Donahue, which was filed on Mar. 19, 2007. The content of the above-referenced application is incorporated herein by reference in its entirety.

### TECHNICAL FIELD

This specification relates to enhancing water flow through media, such as soil, e.g., using low frequency pulses.

### BACKGROUND

Research by the U.S. Department of Agriculture found that lower levels of soil compaction result in effective and efficient use of water for irrigation and enhanced crop yield. Irrigation of grass, plants, and crops use up to 80% of the world's fresh water supplies each year. The trend toward increased reliance on growing alternative energy bio-fuels places a strain on diminishing fresh water supplies. Water shortages and drought conditions are caused by global warming, population growth, population shifts, environmental concerns, and reduced rainfall. Water conservation, more efficient use of potable water, or the replacement of potable water with impaired quality or recycled water for irrigation of crops and turf grass represent alternatives for reducing the severity of droughts and water shortages. Normally, the type of water used for irrigation has a direct bearing on the soil, soil salt levels, and soil compaction levels. Also, the local soil type determines whether water will percolate through the soil or run off. Thus, the system of water, soil, soil salts, and soil compaction create a unique and localized environmental system which is either optimum for the growth of plants and grass with available water or hinders the same. Soil compaction occurs when soil particles are pressed together, thereby reducing the pore space between them and increasing the weight of solids per unit volume of soil (bulk density). Compacted soil can reduce plant growth, reduce root penetration, and root size and distribution, restrict water and air movement in the soil, result in water and nutrient stresses, and cause slow seedling emergence. Research indicates that lower levels of soil compaction result in greater movement of water in soil (hydraulic conductivity), increased oxygenation of soil and plants, and up to 50% increase in plant growth and yield.

Resonance is a property of a system to oscillate at maximum amplitude at certain frequencies, known as resonant frequencies. The resonant frequency of the earth ranges between 0.001 Hz and 30 Hz. Earthquake waves, low frequency waves in rain drops, and other extremely low frequency waves can have a powerful effect on the earth's soil and on plants when applied in a controlled manner relative to frequency and amplitude. Plants have been measured to have natural resonant frequencies which begin as low as 1.6 Hz and extend through harmonics up to 96 Hz. Infrasound is sound with a frequency too low to be detected by the human ear. The frequency of such waves is said to be in the Extremely Low Frequency (ELF) range and covers the range of frequencies from the lower limit of human hearing (20 Hz) down to (0.001 Hz). This frequency range is used in seismography for monitoring earthquakes. Energy waves at these frequencies are characterized by an ability to cover long distances in earth and water without dissipation. ELF waves result naturally from ocean waves, earthquakes, and volcanoes.

### SUMMARY

This specification describes technologies relating to enhancing water mobility in media using low frequency pulses. In one example, an amplified magnetic flux field is generated by positioning like poles of multiple magnets adjacent to each other under pressure sufficient to overcome the quiescent-repulsive force of the magnets. A pulse having a tunable low frequency is induced in water by flowing water through the amplified magnetic field, where the frequency is determined to be a resonant frequency based on a natural frequency of a medium, e.g., soil, through which the pulse-induced water is to be flowed. When the pulse-induced water is transmitted to the soil, the resonant frequency of the pulse in the water produces resonance in the soil, thereby decreasing soil compaction, and enabling water mobility through the medium.

In one aspect, a method includes positioning like poles of two magnets adjacent to create a magnetic flux field at a region corresponding to a position at which the like poles are adjacent, the magnetic flux field based in part on magnetic fields of the two magnets, maintaining pressure sufficient to at least partially overcome a quiescent-repulsive force between the adjacent like poles to amplify the magnetic flux field at the region, flowing water through the amplified magnetic flux field at the region at a flow rate selected based on a natural frequency related to a medium through which the water is to flow, the flowing inducing a pulse in the water having a frequency depending on the selected flow rate, and transmitting the water carrying the pulse at the frequency to the medium to produce resonance with the natural frequency of the medium, the resonance causing a decrease in a compaction of the medium.

This, and other aspects can include one or more of the following features. Decrease in the compaction of the medium permitting the water to flow through the medium. The method can include positioning like poles of additional two magnets adjacent to the two magnets to create an additional magnetic flux field at a region corresponding to a position at which the like poles of the additional two magnets are adjacent, and maintaining pressure sufficient to at least partially overcome a quiescent-repulsive force between the adjacent like poles of the additional two magnets to amplify the additional magnetic flux field. The method can further include separating the two magnets and the additional two magnets by a distance. The method can further include separating the two magnets and the additional two magnets by positioning a spacer between the two magnets and the additional two magnets. The method can further include positioning a first pole of a first magnet of the two magnets adjacent to a first end of a second magnet of the two magnets, the first pole and the first end having a same polarity. The first pole can be a north pole. The quiescent-repulsive force between the like poles can cause the like poles to be positioned at a distance greater than 2 mm from each other in the absence of the pressure. The pressure can cause the like poles to be positioned at a maximum distance of 2 mm from each other. The water can include one or more of salt water, reclaimed water, brackish water, potable water, recycled water, sea water, ocean water, well water, water with high, medium or low total dissolved solids content, or a mixture thereof. The medium can be soil. The natural frequency can be the natural frequency of a plant planted in the soil. Transmitting the water can include transmitting the water through one or more pipes. Transmitting the water can include sprinkling the water. Alternatively or in addition, the water can be transmitted through one or more irrigation methods including drip irrigation, tape irrigation, above-ground overhead sprinkling, above-ground circular irrigation, drive-wheel overhead sprinkling, underground drip irrigation, and the like.

In another aspect, a system includes a first magnet pair positioned such that like poles of both magnets in the first magnet pair face each other, the first magnet pair held under pressure sufficient to at least partially overcome a quiescent repulsive force between the like poles of the first magnet pair, the first magnet pair generating a first amplified magnetic flux field at a region located adjacent the like poles of the first magnet pair, a second magnet pair positioned such that like poles of both magnets in the second magnet pair face each other, the second magnet pair held under pressure sufficient to at least partially overcome a quiescent repulsive force between the like poles of the second magnet pair, the second magnet pair generating a second amplified magnetic flux at a region located adjacent the like poles of the second magnet pair, the first magnet pair positioned at a distance from the second magnet pair, and a first hollow housing to receive the first magnet pair and the second magnet pair.

This, and other aspects, can include one or more of the following features. The system can include a conduit to receive the first hollow housing, the conduit to allow water flow past the first amplified magnetic flux field and the second amplified magnetic flux field, the water flow inducing a pulse at a frequency in the water. The system can include a spacer to position the first magnet pair at the distance from the second magnet pair. The spacer can be made of a non-magnetic material. The magnets in the first magnet pair can be NdFeB N35-N50 nickel coated magnets. The system can further include a first disc and a second disc to close a first end and a second end of the first hollow housing. The system can further include a flow regulator operatively coupled to the conduit to regulate a flow rate of water flowing through the conduit. The system can further include a sprinkler system operatively coupled to a conduit to transmit the water flowing through the second hollowing housing to a medium. The system can further include a pump to flow water through the conduit.

Particular implementations of the subject matter described in this specification can be implemented to realize one or more of the following advantages. The techniques described in this disclosure can deliver highly correlated, measurable, and repeatable results in optimizing water and soil to grow plants and turf. Further, the techniques can be applied to treat water for golf courses, sports fields, greenbelts, food crops, and alternative energy fuel crops including bio-diesel and bio-ethanol. Also, the described methods can enhance the effectiveness and efficiency of all types of water including well water, potable water, brackish water, reclaimed water, and even sea water for growing turf, plants, and crops. The use of described techniques in normal irrigation can reduce the requirement for fresh water in agriculture for growing grass, plants, and crops and can enable achieving enhanced growth yield. This is accomplished by positively impacting water, soil, salts, and soil compaction. Moreover, brackish or reclaimed water can be successfully used to achieve growth yields which are normally associated with fresh or potable water. This can be accomplished by lowering the accumulation of soil salts and soil compaction which would otherwise be the negatives associated with use of these types of water for irrigation.

Furthermore, the techniques described can quickly and effectively reduce soil compaction to optimum levels through normal irrigation and without the use of chemicals. By reducing soil compaction to optimum levels, the movement of water in soil, retention of moisture in soil, and the growth rate of turf and plants can be increased using less water. Producing resonance by transmitting pulse-induced water through the soil allows traveling waves to move unhindered in earth, soil, and water regardless of the type of local soil and water. This unhindered movement of water can help release any and all soil compaction to a great depth when the pulses in the water are introduced into irrigation water. This natural penetration of soil by treated water also can increase the hydraulic conductivity of the water through the soil, and can flush salts through the soil profile in an eco-friendly manner.

Historical soil testing at AgSource Harris Labs indicates a consistent ability of the disclosure to improve and transition difficult soil structures such as clay and calichi into silt and then sand for improved water infiltration and percolation for successful agronomic use of these difficult soil types. Testing also indicates the ability to of the disclosure to positively impact the use of difficult water on difficult soil types either of which contain elevated levels of sodium, chloride, and bicarbonates which create impaired sodic soil types. These elements in water or soil reduce pore spacing of soil particles and negatively impact water infiltration and percolation. This in turn produces standing water and water runoff with environmentally sensitive agronomic chemicals. Also, when the ELF pulses have been applied and the structure improved or compaction released, the soil is allowed to effectively vent CO₂ gases which are essential for healthy plant and turf growth.

The details of one or more implementations of the disclosure are set forth in the accompanying drawings and the description below. Other features, aspects, and advantages will become apparent from the description, the drawings, and the claims.

### BRIEF DESCRIPTION OF THE DRAWINGS

FIG. 1A is a schematic of an example of a system for transmitting pulse-induced water to a medium.

FIG. 1B is a schematic of an example of pressurizing magnets to generate a resultant amplified magnetic flux field.

FIG. 2A is an example of a schematic of a housing including a core assembly for inducing a pulse in water.

FIG. 2B is a table showing exemplary dimensions of various systems for inducing a pulse in water.

FIG. 3 is an example of a schematic of a core assembly used in a system for inducing a pulse in water.

FIG. 4 are examples of pulses of different polarities magnetically induced in water.

FIG. 5 is a flow chart of an example of a process for flowing water carrying a pulse through a medium.

FIG. 6 is a plot of pressure required to penetrate a medium measured over a time period of four weeks.

FIG. 7 is a schematic of an example of a system applying electromagnetism to generate the magnetic flux fields.

Like reference numbers and designations in the various drawings indicate like elements.

### DETAILED DESCRIPTION

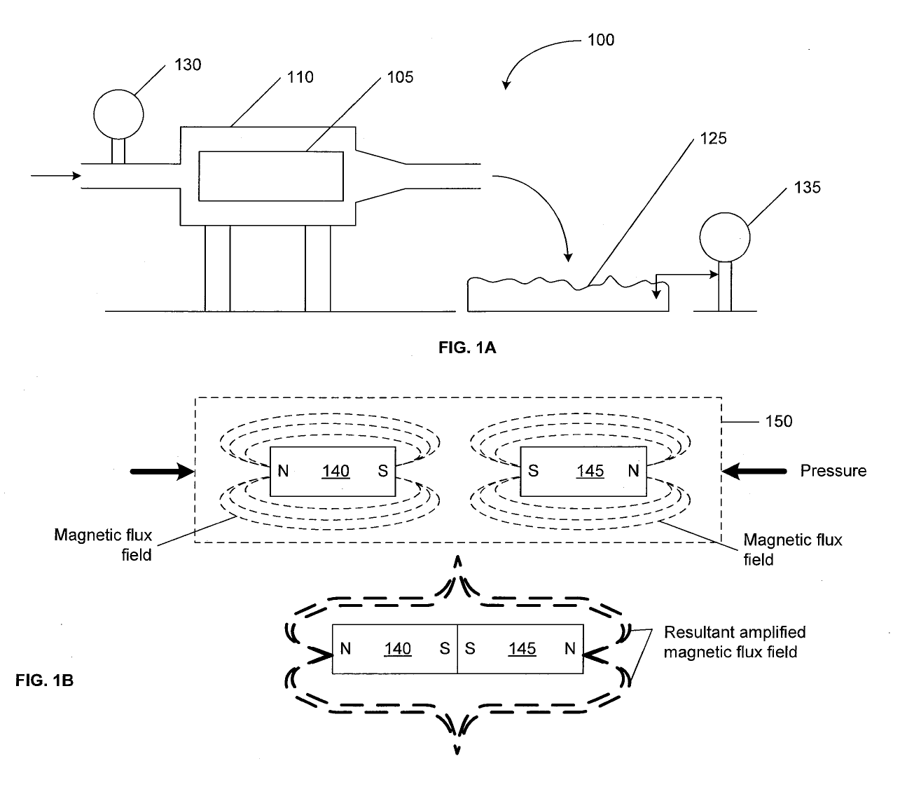

FIG. 1 depicts a schematic of an example of a system 100 for inducing a pulse in water. The system 100 includes a first hollow housing 105 including multiple magnets positioned such that like poles of two adjacent magnets are next to each other under pressure. This arrangement of magnets generates an amplified magnetic flux field extending in a direction perpendicular to the axis of the magnets. The first hollow housing 105 is sealed and positioned inside a conduit 110 configured to receive the first hollow housing 105. The conduit 110 includes an inlet and an outlet to allow water to flow through at a flow rate. As water flows through the amplified magnetic flux field at the flow rate, a pulse is induced in the water at a frequency that depends at least in part on the flow rate of the water through the amplified magnetic flux field. The frequency of the pulse can be tuned to match a natural frequency of a medium 125, e.g., soil, through which the water can be flowed. Factors that allow tuning the frequency of the pulse can include the type of medium, the type of magnets, the number of magnets used, the dimensions of each magnet, a flow rate of the water through the conduit 110, and the like. When the pulse-induced water having a frequency is flowed onto the medium 125 having a natural frequency, because the frequency of the induced pulse was tuned to match the natural frequency of the medium, resonance is produced. An effect of resonance is a reduction in the compaction of the medium, and the permitting water to flow through. Further, in implementations where the medium is soil, salts and other compounds in the soil are released from the soil into the flowing water, further increasing the effectiveness of the soil to grow plants, grass, and other crops. In some implementations, the system 100 can include a flow regulator 130 operatively coupled to the inlet of the conduit 110 to control the flow rate of water. In some implementations, the system 100 can include a compaction detection device 135 to detect a compaction of the soil through which the pulse-induced water is flowed.

In reactive methods of implementation, the effect of pulse-induced water is measured, and in response, the frequency of the pulse is tuned. In such implementations, the water is flowed at a flow rate through the conduit 110 and past the amplified magnetic flux field generated by the first hollow housing 105, thereby inducing a pulse in the water. The pulse-induced water is flowed through the medium 125, and the compaction of the medium is measured using the device 135. If a decrease in compaction is measured, then the decrease can be attributed to a resonance produced between the frequency of the pulse in the water and the natural frequency of the medium. If a decrease in compaction is not measured, then the flow rate can be adjusted using the flow regulator 130 to change the frequency of the pulse in the water. Alternatively or in addition, parameters of the magnets and the components of the first hollow housing can be modified to change the frequency. In such implementations, the frequency of the pulse induced in the water is tuned depending on the compaction measured after the water is flowed into the soil.

In predictive methods of implementation, a frequency of the pulse is determined prior to inducing the pulse in the water, such that the determined frequency falls within a range of the natural frequency that will produce resonance. In such implementations, the choice of magnets, magnet dimensions, flow rate, and the like can be used to determine a frequency of a pulse that will be induced when water is flowed at the selected flow rate through the conduit 110 and through the amplified magnetic flux field. The determined frequency can be chosen to match the natural frequency of the medium 125 through which the pulse-induced water will flow. In this manner, the frequency of the pulse in the water can be tuned to match the natural frequency and, in turn, to produce resonance in the medium 125 before the water is transmitted to the soil.

FIG. 1B is a schematic of an example of pressurizing magnets to generate a resultant amplified magnetic flux field. The first hollow housing 105 includes multiple magnets arranged with like poles of two magnets positioned adjacent to each other. For example, a south pole of a first magnet 140 can be positioned adjacent to a south pole of a second magnet 145 to form a magnet pair 150. Positioning the two magnets 140 and 145 with like poles facing each other generates a magnetic flux field at a region adjacent to the like poles of the magnet pair. Due to physics, the two like poles repel each other by a quiescent repulsive force. In the example described here, the axes of the two magnets are co-linear, although in other examples, the axes of the two magnets need not be co-linear. A pressure is applied to the two magnets 140 and 145 such that the quiescent repulsive force is at least partially overcome, and the like poles of the two magnets 140 and 145 are positioned close to each other. This pressurization of the two magnets generates a resultant amplified magnetic flux field generated at the region near the poles, and causes the magnetic flux field to extend in a direction perpendicular to the axis of the two magnets.

In some implementations, a magnet in the magnet pair can be a cylindrical magnet having flat edges. In such implementations, the amplified magnetic flux field can extend in a radially away from the cylindrical magnets. Although the example described here includes a cylindrical magnet with flat edges, magnets having any cross-sectional shape and any edge shape can be used in the system 100. For example, the cross-section of the magnet can have a regular geometric shape, such as an ellipse, any polygon, or can be have any other shape, e.g., any irregular shape. In some implementations, the length of a magnet can be greater than the cross-sectional dimension of the magnet or vice versa. In some implementations, the length and the cross-sectional dimensions of the magnets can be equal. Each pole of a magnet can have a shape that is different from a flat edge, e.g., tapered edge, rounded edge, convex edge, concave edge, and the like, and one pole of the magnet can have a different shape than the other pole of the magnet. Like poles positioned adjacently can have the same or different shapes. It is postulated that the cross-sectional shape of a magnet and the shape of a magnet's edges (the poles) will affect the resultant amplified magnetic flux field that is generated when the two magnets are held under pressure. Therefore, the choice of cross-section and edge shape are not based on the design of the system 100 alone. The first hollow housing 105 can be made of a suitable material, e.g., stainless steel. In alternative implementations, the first hollow housing 105 can be made from any material which is magnetically inert to prevent undesirable influence on the specific flux fields which are created by the pressurized permanent magnets. The material can be selected to be structurally strong so as to maintain co-linear alignment of the magnets. A list of materials includes Plastic piping (PVC), fiberglass, carbon fiber, aluminum, or other such materials.

The strength of the magnets, e.g., the flux value of the magnets, can be chosen such that the like quiescent-repulsive force is significant. In some implementations, the flux value of each magnet can be as high as 4500 Gauss or higher. For example, the strength of the magnets can be selected such that, in the absence of pressure, and at rest, the like poles are greater than 2 mm apart from each other. To at least partially overcome the quiescent repulsive force, a pressure can be applied to the two magnets and the like poles can be positioned within a distance of 2 mm from each other. In some implementations, sufficient pressure can be applied to cause the north pole of the first magnet to be in complete contact with the north pole of the second magnet. In some implementations, the pressure can cause the like poles to be 1 mm apart. In some implementations, the pressure applied to at least partially overcome the quiescent-repulsive force can be as high as 3000 psi (˜20.6 MN/m²) or higher.

In some implementations, the first hollow housing 105 can include multiple holes to receive multiple pins that can be inserted into the holes. A first magnet can be positioned adjacent to one or more pins inserted into the first hollow housing 105 to retain the first magnet. Subsequently, the second magnet can be introduced into the first hollow housing 105 at an orientation such that like poles of the first and second magnets are adjacent to each other. Upon retaining the first magnet in the first hollow housing 105 using one or more retaining pins, a pressure can be applied to move the like pole of the second magnet closer to the like pole of the first magnet. Once a desirable distance between the like poles is reached, pins can be inserted into the holes to retain the second magnet. In some cases, the like poles can be brought in contact with each other. This is one example by which a first magnet pair can be assembled inside a first hollow housing. Although the example describes pins to retain the magnets in place, other mechanisms are also possible. In some implementations, any form of fastener can be used to retain the first and second magnets in predetermined positions. In some implementations, the internal surface of the first hollow housing 105 can include multiple rims positioned equidistantly from each other. A magnet can be retained when positioned against a rim or a varying thickness circular shim which is inserted under pressure and between the inside wall of the first hollow housing and the outer diameter of the magnets which comprise the core.

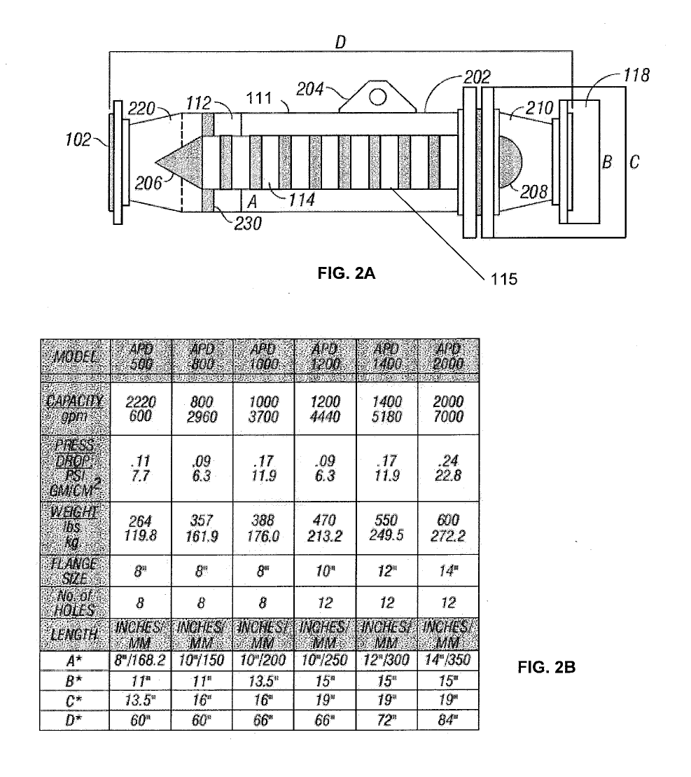

FIG. 2A is an example of a schematic of two hollow housings including a plurality of magnets including a first magnet pair and a second magnet pair assembled for inducing a pulse in water. The assembly 111 has input part 102 which may be a screw thread or any desired other kind of thread. The assembly 111 includes a first hollow housing 115 and a conduit 202. The first hollow housing 115 includes a first magnet pair and a second magnet pair, where the magnet pairs are positioned such that like poles of both magnets in the magnet pair face one another. The magnets in the magnet pair are held under pressure sufficient to at least partially overcome a quiescent repulsive force between the like poles of the magnet pair to generate an amplified magnetic flux field at a region located adjacent the like poles of the magnet pair.

The first hollow housing is positioned inside a conduit 202 of the water conditioner assembly 111. The conduit 202 is most desirably formed of stainless steel or carbon steel in order to maintain the proper magnetic effect. The conduit 202 is coated internally with an epoxy/ceramic paint such as manufactured by Ceramkote, to prevent electrolysis induced by the water flowing through the very high density magnetic flux fields contained within the conduit 202. The conduit 202 is also firmly grounded by attaching a ground wire between the conduit 202 and the ground. The grounding and coating can resist the negative and corrosive effects of electrolysis.

Connecting portion 204 connects to the conduit 202 and may allow mounting of the device on a cart or in a permanent installation. The inside chamber 112 includes a water treatment part 114 therein. The water treatment part has a substantially beveled presentation part 206. The input water is distributed coaxially around the treatment part by this input surface. The water then travels through the chamber 112, and past the first hollow housing 115 until it reaches the end portion 208. The end portion 208 includes a substantially convex rounded surface 208 to create turbulence, helping the water to mix in the mixing chamber 210. Two tapered areas are provided: a first area 220 which increases the diameter of the tube from the opening area 102 to the increased diameter area of the chamber 112. A second area 210, within the mixing chamber, reduces the area down back to the original area of the hose at 118. Additional details describing the components of the system 100 can be found in the patent application titled “Water Conditioner Device,” (US Patent Application Publication No. 20070205158 A1, filed Mar. 6, 2006, published Sep. 6, 2007), the entire contents of which are incorporated herein by reference.

FIG. 2B depicts a table showing exemplary dimensions of various systems for inducing a pulse in water. The exemplary dimensions, labeled A, B, C, and D refer to the diameter of the chamber 112, and the overall length of the unit. The different units with their model numbers, and capacity, both in gallons per minute and liters per minute, are shown in FIG. 2B.

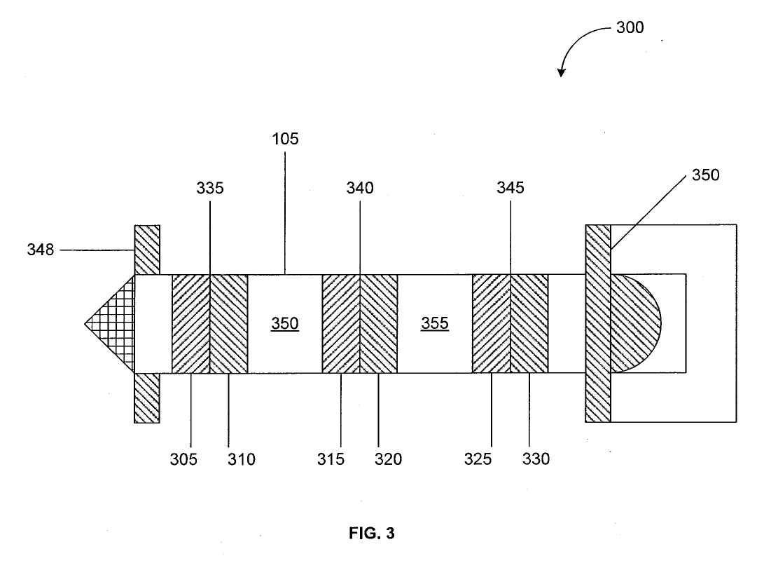

FIG. 3 is an example of a schematic of a core assembly 300 used in a system for inducing a pulse in water. The core assembly 300 includes multiple magnets 305, 310, 315, 320, 325, and 330 positioned within the first hollow housing 105 which, in some implementations, is cylindrical. In the example core assembly 300 shown in FIG. 3, magnets 305 and 310 form a first magnet pair, magnets 315 and 320 form a second magnet pair, and magnets 325 and 330 form a third magnet pair. Although the example illustrates three magnet pairs, the core assembly 300 can include multiple magnet pairs. In some implementations, the core assembly 300 can have uneven number of magnets such that not all magnets are included in magnet pairs. In some implementations, the core assembly 300 is at least 55 inches (˜140 cm) long and approximately 6 inches (˜15 cm) in diameter. The multiple magnets can be approximately 6 inches (˜15 cm) in diameter and be selected from NdFeB N35 to N50 magnets.

Additional dimensions and magnet sizes are applicable for lower total flow rates in Gallons per minute (GPM). For example, when an 8″ outer housing diameter is called for to achieve proper GPM flow rate at 8-9 feet per second, then 4″ diameter NdFeB N35 to N50 magners are used in the core. In another example, when a 6″ outer housing diameter is used for proper GPM flow rate at 8-9 feet per second, a 3″ diameter core with NdFeB N35 to N50 magners is used. For another example, when a 4″ outer housing diameter is used for proper GPM flow rate at 8-9 feet per second, a 2″ diameter core with NdFeB N35 to N50 magners is used. In consumer applications where a 1.5″ to 2.0″ outer housing is used for proper flow rate and volume, a core with 0.75″ to 1.0″ NdFeB N35 to N50 is used. In some implementations, the core assembly 300 can be less than 55 inches long and can include magnets of any dimensions. Although exemplary dimensions are provided, the core assembly, the magnets, and the hollow housings can be of any dimensions.

A first magnet pair including magnets 305 and 310 can be positioned under pressure such that like poles of magnets 305 and 310 are adjacent to each other, e.g., in contact with each other. For example, the north pole of magnet 305 can be positioned under pressure adjacent to the north pole of magnet 310. The core assembly 300 includes a spacer 350 positioned between the first magnet pair including magnets 305 and 310, and the second magnet pair including magnets 315 and 320. The spacer 350 can be made of a non-electric, non-magnet material, e.g., wood, plastic, and the like. Similarly, a second spacer 355 can be positioned between the second magnet pair and the third magnet pair including magnets 325 and 330.

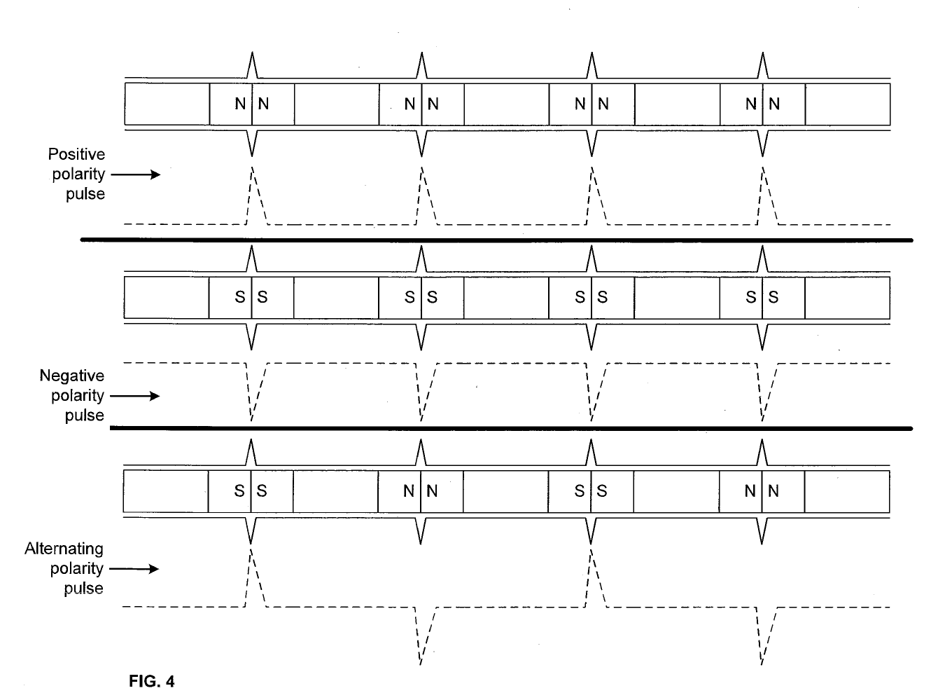

FIG. 4 depicts examples of pulses of different polarities magnetically induced in water. In some implementations, the north poles of the magnets of the first magnet pair can be positioned adjacent to each other and the south poles of the magnets of the second magnet pair can be positioned adjacent to each other with the spacer 350 between the first magnet pair and the second magnet pair. In some implementations, the north poles of the magnets of the second magnet pair can be positioned adjacent to each other and the north poles of the magnets of the third magnet pair can be positioned adjacent to each other with the spacer 355 positioned between the first magnet pair and the second magnet pair. In this manner, the spacer 350 enables positioning any two like poles of magnets of a magnet pair adjacent to each while also enabling maintaining a distance between two amplified magnetic flux fields. Thus, all the amplified magnetic flux fields established by magnet pairs in a core assembly 300 can have a same polarity. This means that the like poles of all the magnetic pairs in the core assembly 300 are the same, e.g., either the north poles or the south poles. Alternatively, the amplified magnetic flux fields can have a different polarity when like poles of different magnetic pairs in the core assembly 300 are different. This feature of the core assembly 300 provided by the spacers allows creating alternating flux fields where the amplified magnetic flux fields created by alternately positioned magnet pairs have alternating polarity. As a convention, it is assumed that amplified resultant magnetic flux fields created by north poles of magnets in a magnet pair are positive amplitude fields and amplified resultant magnetic flux fields created by south poles of magnets in a magnet pair are negative amplitude fields. Under these conditions, the pulse induced when water is flowed through the magnetic fields established by the core assembly can have one of only negative amplitudes, only positive amplitudes, or a combination of amplitudes, e.g., alternating amplitudes. In some implementations, the core assembly 300 includes disks 348 and 350, e.g., made of stainless steel, to seal the core assembly 300 and prevent entry of water between the magnets and the spacers.

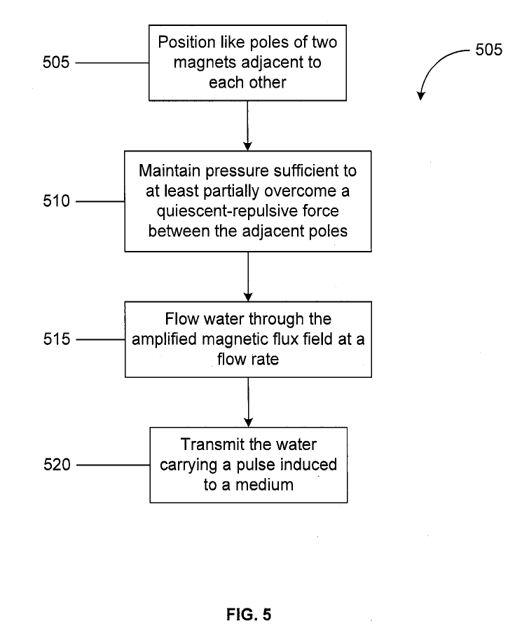

FIG. 5 is a flow chart of an example of a process 500 for flowing water carrying a pulse through a medium. The process 500 positions like poles of two magnets adjacent to create a magnetic flux field at a region corresponding to a position at which the like poles are adjacent at 505. The magnetic flux field is based at least in part on magnetic fields of the two magnets. For example, two N35 NdFeB magnets having magnetic fields between 12000 and 14000 G, can be positioned such that a north pole of a first magnet of the two magnets is positioned adjacent to a north pole of the second magnet of the two magnets. The two magnets can be positioned inside a first hollow housing.

The process 500 applies pressure sufficient to at least partially overcome a quiescent-repulsive force between the adjacent like poles to amplify the magnetic flux field at the region at 510. For example, one of the two magnets in the first hollow housing can be held in place while the other magnet is pushed towards the magnet held in place, where the force applied to push the magnet is greater than the repulsive force at the two like poles. In some implementations, both magnets can be pushed towards each other. This pressurization of the two magnets amplifies the magnetic flux field at the region adjacent to the like poles, and causes the amplified magnetic flux field to extend uniformly in a direction perpendicular to the axes of the magnets. Thus, if the two magnets are cylindrical, then the amplified magnetic flux field extends in the radial direction. The ends of the first hollow housing in which the magnets are positioned under pressure can be sealed, e.g., using flat discs fastened to both ends of the housing. To provide additional amplified magnetic flux fields, additional pairs of magnets can be positioned under pressure within the hollow housing. Two pairs of magnets can be positioned adjacent to each other or alternatively can be separated using spacers.

The process 500 flows water through the amplified magnetic flux field at the region at a flow rate at 515. The flow rate is selected based on a natural frequency related to a medium through which the water is to be flowed. Flowing water through the amplified magnetic flux field induces a pulse having a frequency in the water, where the frequency of the pulse depends on the selected flow rate. For example, the first hollow housing containing the magnets under pressure can be positioned within a conduit that includes an inlet and an outlet for water flow. When water is flowed through the amplified magnetic flux field, a pulse having a frequency is induced in the water. For example, water can be flowed into the inlet of the conduit, e.g., using a pump, past the first hollow housing, and out of the outlet of the conduit.

The frequency of the pulse depends on factors including the amplified magnetic flux field, which, in turn, depends on the magnetic fields of the magnets, the dimensions of the magnets, a distance between two magnet pairs, the polarity of the like poles, and the like, as well as the flow rate of the water. The factors that affect the frequency of the pulse can be selected based on a natural frequency of a medium, e.g., soil, through which the pulse-induced water is to be flowed, e.g., for irrigational purposes. For example, the factors affecting the frequency of the pulse can be selected to match the natural frequency of the medium through which the water is to be flowed.

The process 500 transmits the water carrying the pulse at the frequency to the medium at 520. For example, the outlet of the conduit can be connected to the soil through one or more pipes, and the pulse-induced water can be flowed to the soil through the one or more pipes. Alternatively, the outlet of the conduit can be operatively coupled to a sprinkler system that can be used to sprinkle water on the soil. In some implementations, any suitable mechanism to transmit water from the conduit to the medium can be operatively coupled to the conduit. Because the frequency of the pulse in the water is tuned to match the natural frequency of the soil, resonance is produced, which causes a decrease in a compaction of the medium, thereby permitting the water to flow through the medium. The water that is flowed through the conduit can be of any type including but not limited to high salinity water, sea water, reclaimed water, recycled water, reclaimed water, effluent water, high medium and low TDS (total dissolved salts/solids) water, brackish water, well water, potable water, or a mixture thereof.

Tuning the frequency of the pulse induced in the water can be achieved by methods including one or more of changing the strength of the magnets, the number of magnets in a core assembly, the dimensions of the magnets, the distance between two like poles, the dimensions of the spacers between the magnets, the polarity of the amplified magnetic flux fields, the flow rate of the water, and the like. The range of frequencies of the pulses that can be induced in the water are collectively known as Extremely Low Frequencies (ELF) and can be 30 Hz or lower. In one example, a core assembly that is nearly 40 inches long (˜100 cm) including eighteen compressed magnets is positioned in a first hollow housing. The flow rate of water through the amplified resultant magnetic flux fields generated by the magnet pairs in the core assembly is nearly 8 ft/second (˜2.5 m/s). Under this arrangement, eight full cycle waves having a frequency of nearly 19 Hz were induced in the water in 0.42 seconds. The frequency induced in the pulse falls within the range of Schumann's resonance frequency of earth, which is between 18.7 Hz and 22.9 Hz. Other Schumann's resonance frequency ranges of earth include 7.1 Hz-8.6 Hz, 12.8 Hz-15.7 Hz, 24.6 Hz-30 Hz, and 30.4 Hz-37.2 Hz. The parameters of the system 100 can be altered to cause the induced pulses to have a frequency that falls within any one of these ranges. Alternatively, if the medium is different from soil, then other ranges of frequencies can be determined, and the frequency of the pulse induced can be tuned accordingly.

The implementations described in this disclosure can be applied to soils that has a high clay content. The non-chemical nature of the water treatment described in this disclosure can be used to break down compacted clay in the soil allowing the soil to retain moisture. When the techniques described in this disclosure were tested on the soil in a golf course, better water penetration and better root mass was observed, in addition to better secondary root growth. The soil that used to be dispersed became flocculated soil enabling better use of soil nutrients and minerals. Base saturation tests revealed better availability of nutrients to the plans. An increase in the root depth of nearly 1 to 2 inches was observed. Secondary growth of roots was also observed resulting in a better uptake of moisture and nutrients to the plans, resulting in fuller plants that have a better capability to withstand drought. In addition, the pulse-induced water allowed better leaching to take place moving salts and bicarbonates in the soil out of the root area providing more ability for the plants to grow. The quality of the soil improved along with a 15% to 20% reduction in water consumption. Application of the techniques described in this disclosure also result in an increase in solubility of nutrients such as NO₃, NH₄, P, K, Ca, Mg, SO₄, Cl, Na, and the like.

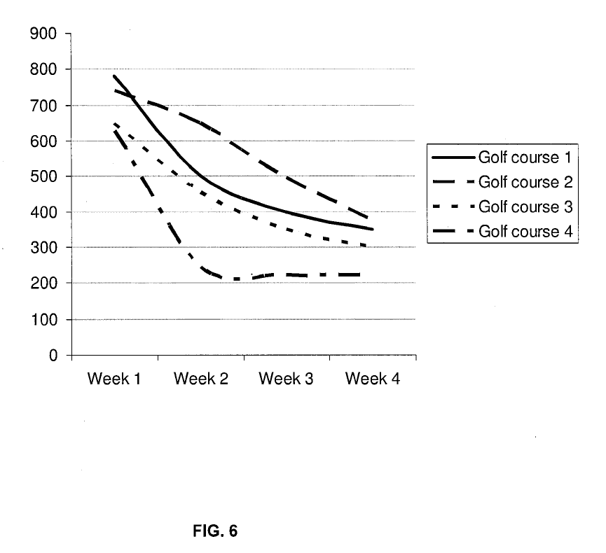

FIG. 6 is a plot of pressure required to penetrate a medium measured over a time period of four weeks. The plot shows compaction readings at four golf courses that started with readings between 600 psi and 800 psi during week 1 before treatment by the pulse-induced water. Penetration beyond 1 inch could not be achieved prior to treatment. Within 30 days, compaction was reduced to the 200 psi to 400 psi range, and probe penetration increased by at least 12 inches.

It is postulated that electro-conductivity of all salt carrying solutions including water and soil is one of the reasons that pulses having extremely low frequencies can be established and transmitted in water. The salts in water were previously detrimental to the efficient use of water for turf grass and plants. In contrast, the techniques described here enable the use of the electro-conductivity properties of water to develop, induce, and propagate resonant frequency energy in the ELF range through irrigation water, that is then delivered to soil and turf through normal irrigation. The ELF energy is broadly resonant with earth, soil, plants, and turf which causes decrease in soil compaction, increase in hydraulic conductivity of water, increase in permeability of water into soil, increase in solubility of minerals and nutrients in soil, especially without reliance on chemical treatment, increase root growth and root mass of plants, leaching of harmful salts away from plant roots ultimately reducing water consumption. Other applications of this disclosure include delivering agronomic chemicals using pulse-induced water through compacted soils to cure soil and plant diseases, providing environmental solutions for growing ethanol and other bio energy fuel crops with higher yield, faster growth, and carbohydrate yield.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations have been described. Some implementations are within the scope of the following claims. In some implementations, the core assembly can include hollow, ring magnets assembled in a tubular housing having an inner and outer diameter. An outer diameter of the conduit through which water is flowed can be smaller than the inner diameter of the tubular housing. In such an implementation, the water can be flowed through the core assembly instead of around it.

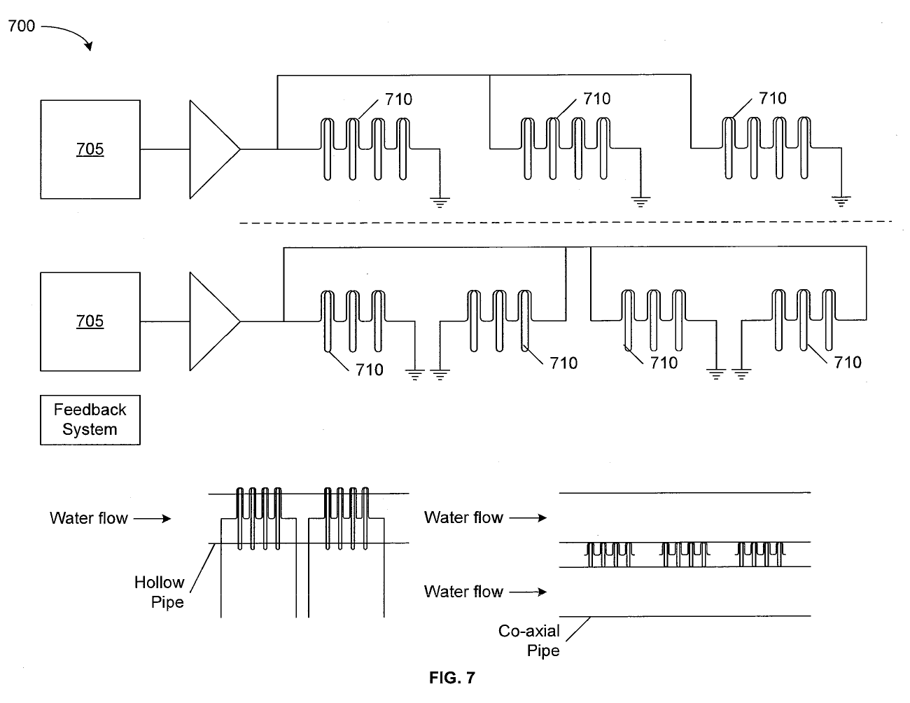

FIG. 7 is a schematic of an example of a system 700 applying electromagnetism to generate the magnetic flux fields. The electromagnetic system 700 includes a variable frequency pulse generator 705 to deliver square waves or triangle waves through an amplifier to electromagnetic coils 710 wrapped around a hollow pipe through which water is flowed. The electromagnetic coils 710 are wound around the pipes, e.g., 50 windings/coil, and separated by a distance to facilitate induction and subsequent amplification of ELF pulses into the water flowed through the pipe. The coils are electrically coupled in parallel (same polarity spaced equidistant) to induce positive or negative pulses or electrically coupled in parallel (opposite polarity spaced equidistant) to induce positive and negative pulses into the water. For example, a housing through which water is flowed can be wrapped with an electromagnetic coil that induces a magnetic field around the housing. Multiple induction coils can be wrapped around the housing and separated from each other to generate multiple magnetic flux fields through which the water is flowed. The effect of the pulse-induced water can be determined and fed back to the pulse generator 705 using a feedback system 715. The feedback system 715 can tune the pulse based on factors including soil compaction, electro-conductivity, salt content, and the like. In alternative implementations, the water can be flowed through coaxial pipes and the electromagnetic coil can be positioned within the coaxial pipe.

What is claimed is:

1. A method comprising:
positioning like poles of two magnets adjacent to create a magnetic flux field at a region corresponding to a position at which the like poles are adjacent, the magnetic flux field based in part on magnetic fields of the two magnets;
maintaining pressure sufficient to at least partially overcome a quiescent-repulsive force between the adjacent like poles to amplify the magnetic flux field at the region;
flowing water through the amplified magnetic flux field at the region at a flow rate selected based on a natural frequency related to a medium through which the water is to flow, the flowing inducing a pulse in the water having a frequency depending on the selected flow rate; and
transmitting the water carrying the pulse at the frequency to the medium to produce resonance with the natural frequency of the medium, the resonance causing a decrease in a compaction of the medium.

2. The method of claim 1, wherein the decrease in the compaction of the medium permitting the water to flow through the medium.

3. The method of claim 1, further comprising:
positioning like poles of additional two magnets adjacent to the two magnets to create an additional magnetic flux field at a region corresponding to a position at which the like poles of the additional two magnets are adjacent; and
maintaining pressure sufficient to at least partially overcome a quiescent-repulsive force between the adjacent like poles of the additional two magnets to amplify the additional magnetic flux field.

4. The method of claim 3, further comprising separating the two magnets and the additional two magnets by a distance.

5. The method of claim 4, further comprising separating the two magnets and the additional two magnets by positioning a spacer between the two magnets and the additional two magnets.

6. The method of claim 1, further comprising positioning a first pole of a first magnet of the two magnets adjacent to a first end of a second magnet of the two magnets, the first pole and the first end having a same polarity.

7. The method of claim 6, wherein the first pole is a north pole.

8. The method of claim 1, wherein the quiescent-repulsive force between the like poles causes the like poles to be positioned at a distance greater than 2 mm from each other in the absence of the pressure, and wherein the pressure causes the like poles to be positioned at a maximum distance of 2 mm from each other.

9. The method of claim 1, wherein the water includes one or more of salt water, reclaimed water, brackish water, potable water, recycled water, sea water, ocean water, well water, water with high, medium or low total dissolved solids content, or a mixture thereof.

10. The method of claim 1, wherein the medium is soil.

11. The method of claim 10, wherein the natural frequency is the natural frequency of a plant planted in the soil.

12. The method of claim 1, wherein transmitting the water further comprises transmitting the water through one or more pipes.

13. The method of claim 1, wherein transmitting the water further comprises sprinkling the water.

14. The method of claim 1, wherein transmitting the water includes transmitting by one or more of drip irrigation, tape irrigation, above-ground overhead sprinkling, above-ground circular irrigation, drive-wheel overhead sprinkling, underground drip irrigation or combinations thereof.

15. A system comprising:
a first magnet pair positioned such that like poles of both magnets in the first magnet pair face each other, the first magnet pair held under pressure sufficient to at least partially overcome a quiescent repulsive force between the like poles of the first magnet pair, the first magnet pair generating a first amplified magnetic flux field at a region located adjacent the like poles of the first magnet pair;
a second magnet pair positioned such that like poles of both magnets in the second magnet pair face each other, the second magnet pair held under pressure sufficient to at least partially overcome a quiescent repulsive force between the like poles of the second magnet pair, the second magnet pair generating a second amplified magnetic flux at a region located adjacent the like poles of the second magnet pair, the first magnet pair positioned at a distance from the second magnet pair; and
a first hollow housing to receive the first magnet pair and the second magnet pair.

16. The system of claim 15, further comprising a conduit to receive the first hollow housing, the conduit to allow water flow past the first amplified magnetic flux field and the second amplified magnetic flux field, the water flow inducing a pulse at a frequency in the water.

17. The system of claim 15, further comprising a spacer to position the first magnet pair at the distance from the second magnet pair.

18. The system of claim 17, wherein the spacer is made of a non-magnetic material.

19. The system of claim 15, wherein magnets in the first magnet pair are NdFeB N35-N50 nickel coated magnets.

20. The system of claim 15, further comprising a first disc and a second disc to close a first end and a second end of the first hollow housing.

21. The system of claim 15, further comprising a flow regulator operatively coupled to the conduit to regulate a flow rate of water flowing through the conduit.

22. The system of claim 15, further comprising a sprinkler system operatively coupled to a conduit to transmit the water flowing through the second hollowing housing to a medium.

23. The system of claim 15, further comprising a pump to flow water through the conduit.
